(19) United States
(12) Patent Application Publication
(10) Pub. No.: US 2006/0212938 A1
(43) Pub. Date: Sep. 21, 2006

(54) Electronic device, registration method thereof, and storage medium

(75) Inventor: Ryuichi Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/159,115

(22) Filed: Jun. 23, 2005

(30) Foreign Application Priority Data
Mar. 18, 2005 (JP) 2005-080701

(51) Int. Cl. G06F 12/14

(52) U.S. Cl. 726/16

(57) ABSTRACT

Regarding an electronic device capable of registration in order to maintain linkage relationships with other devices and the like, simplification of device registration is provided by eliminating the need of input of the secret identification numbers or the like. The electronic device includes a device information acquisition unit obtaining device information from a counterpart device which is a registration target; a storage unit storing device information representative of the registration target; and a secret identification information generation unit comparing the device information stored in the storage unit with the device information obtained from the counterpart device and generating secret identification information applied to the counterpart device if both of the device information are identical.

### BACKGROUND OF THE INVENTION

1. Field of the Invention

The present invention relates generally to an electronic device which can complement a function with other electronic devices and, more particularly, to an electronic device, a registration method thereof, and storage medium which establish a functional linkage with a counterpart device by registration, such as in the case of a cellular phone and a headset.

2. Description of the Related Art

When an electronic device complements a function with other device, for example, in the case of a cellular phone, the other device complementing the function includes a headset (a headphone with a microphone), the other telephone and the like. The cellular phone has multiple functions such as a telephone call function and a data communication function, while the headset, i.e. the other device, has a hands-free function for freeing hands from the cellular phone. Therefore, by connecting the headset with the cellular phone, the hands-free function can be utilized, and by using a close-range radio communication function, such as Bluetooth, which is provided on the cellular phone and headset, the convenience of telephone calls can be enhanced due to cordless calls. However, for establishing a linked relationship between these devices, registration processing is required between the devices. It is desired that such registration processing between the devices to be simplified.

For registration between the conventional devices, a default secret identification number may be used for the registration, and although such use of the secret identification number can eliminate input of the secret identification number from one of both devices to be registered, a complicated registration procedure must be followed in processing for the other device.

In regard to these device registrations or the like, for example, Japanese Patent Application Laid-Open Publication No. 2004-302910 exists for storing information of images of the head or body of the user corresponding to a device number possessed by the cellular phone in a storage unit in advance and for executing processing to make the information in the storage unit correspond to information selected by the user as needed.

In the technologies disclosed in paragraph numbers 0035, 0036, 0044, 0045 and 0049 and FIGS. 10, 11, 12 and 14 of Japanese Patent Application Laid-Open Publication No. 2004-302910, the device number of the cellular phone registered in advance and information representing the user are registered from the cellular phone side to the processing apparatus side, and the registered information is made correspond to merchandise information provided on the internet from the cellular phone by the processing apparatus. These technologies are completely different from registration processing of mobile terminals and devices and do not fit to the processing.

Although, as described above, the registration between electronic devises requires complicated processing operations such as input of the secret identification number, disclosure or indication is not provided by Japanese Patent Application Laid-Open Publication No. 2004-302910 regarding problems with simplification of such processing, and such problems can not be solved by the technologies disclosed in the Patent Application.

### SUMMARY OF THE INVENTION

It is therefore an object of the present invention to provide an electronic device capable of registration in order to maintain linkage relationships with other devices and the like, with simplification of device registration by eliminating the need of input of the secret identification numbers or the like.

In order to achieve the above object, according to a first aspect of the present invention there is provided an electronic device comprising a device information acquisition unit obtaining device information from a counterpart device which is a registration target; a storage unit storing device information representative of the registration target; and a secret identification information generation unit comparing the device information stored in the storage unit with the device information obtained from the counterpart device and generating secret identification information to be applied to the counterpart device if both of the device information are identical.

According to such a configuration, the storage unit stores and saves the device information such as the device name of the counterpart device to be registered, and the device information acquisition unit obtains the device information of the counterpart device to be registered. Then, the secret identification information generation unit compares the obtained device information with the device information already held and automatically generates the secret identification information if both are identical. Therefore, input operations are not needed for the secret identification information such as the secret identification numbers, and the device registration operations are simplified on the user side.

In the electronic device, the secret identification information may be generated by use of a device address obtained from the counterpart device.

The electronic device may further comprise an authentication information generation unit generating authentication information used for authentication of the counterpart device from the secret identification information generated in the secret identification information generation unit. According to such a configuration, the authentication information used for the authentication of the counterpart device can be generated by the authentication information generation unit from the secret identification information generated in advance. The device registration operations are also simplified on the user side by this processing.

In the electronic device, the secret identification information generation unit may compare the device information stored in the storage unit with device information of the counterpart device and generate display information prompting input of secret identification information to be applied to the counterpart device, if both of the device information are not identical.

The device information acquisition unit may read out device information displayed on the counterpart device which is the registration target, from an image.

In order to achieve the above object, according to a second aspect of the present invention there is provided an electronic device comprising a notification unit transmitting a notification representative of a registration request upon receiving the registration request from a counterpart device; a selection unit selecting whether to respond to the registration request; and a communication unit notifying a counterpart device of instruction information identified by the selection unit. According to such a configuration, when receiving the registration request from the counterpart device, the notification unit notifies that the request has been made. The user can find the registration request due to the notification from the notification unit and, when receiving the notification, the user can select whether to respond to the registration request or not. If the registration request is refused, the registration processing is cancelled, and if responded, the registration processing is continued. By selecting whether to respond to the registration request or not in this way, order and reliability of the device registration can be maintained. In other words, unwanted registrations can be prevented.

In order to achieve the above object, according to a third aspect of the present invention there is provided a registration method of an electronic device, comprising the operations of obtaining device information from a counterpart device which is a registration target; comparing device information stored in a storage unit with the device information obtained from the counterpart device; and generating secret identification information to be applied to the counterpart device if both of the device information are identical in the comparison. According to such a registration method, above described registration processing is automated, and the input of the secret identification information or the like can be eliminated for realizing the simplification of the registration processing.

The registration method of an electronic device may further comprise the operation of generating authentication information used for authentication of the counterpart device from the secret identification information.

The registration method of an electronic device may further comprise the operation of comparing the device information stored in the storage unit with device information of the counterpart device and generating display information prompting input of secret identification information to be applied to the counterpart device, if both of the device information are not identical.

The registration method of an electronic device may further comprise the operation of reading out device information displayed on the counterpart device which is the registration target, from an image.

In order to achieve the above object, according to a forth aspect of the present invention there is provided a computer readable storage medium storing an electronic device registration program executed by a computer, the electronic device registration program comprising the steps of obtaining device information from a counterpart device which is a registration target; comparing device information stored in a storage unit with the device information obtained from the counterpart device; and generating secret identification information to be applied to the counterpart device if both of the device information are identical in the comparison.

In the computer readable storage medium, the electronic device registration program may further comprise the step of generating authentication information used for authentication of the counterpart device from the secret identification information.

In the computer readable storage medium, the electronic device registration program may further comprise the step of comparing the device information stored in the storage unit with device information of the counterpart device and generating display information prompting input of secret identification information to be applied to the counterpart device, if both of the device information are not identical.

In the computer readable storage medium, the electronic device registration program may further comprise the step of reading out device information displayed on the counterpart device which is the registration target, from an image.

Thus, according to the present invention, simplification can be implemented in the device registration conventionally requiring complicated efforts in registration between the devices, and the convenience of the electronic devices can be enhanced in terms of coordination and complementation of functions among multiple devices.

Other objects, features and advantages of the present invention will become more apparent from the following detailed description of the embodiments with reference to the accompanying drawings.

### BRIEF DESCRIPTION OF THE DRAWINGS

FIG. 1 is a block diagram showing an electronic device according to a first embodiment;

FIG. 2 is a diagram showing a configuration example of an electronic device;

FIG. 3 is a flowchart associating processing on the cellular phone side with processing on the headset side;

FIG. 4 is a flowchart associating processing on the cellular phone side with processing on the headset side;

FIG. 5 is a flowchart showing registration processing of the cellular phone and headset;

FIG. 6 is a flowchart showing registration processing of the cellular phone and headset;

FIGS. 7A to 7C are diagrams showing display contents on the cellular phone;

FIGS. 8A to 8C are diagrams showing display contents on the cellular phone;

FIG. 9 is a block diagram showing an electronic device according to a second embodiment;

FIG. 10 is a diagram showing a configuration example of the electronic device;

FIG. 11 is a flowchart associating processing on the cellular phone side with processing on the headset side;

FIG. 12 is a flowchart showing registration processing of the cellular phone and headset;

FIGS. 13A to 13C are diagrams showing display contents on the cellular phone;

FIG. 14 is a diagram showing an electronic device according to other embodiment; and

FIG. 15 is a diagram showing an electronic device according to other embodiment.

### DETAILED DESCRIPTION OF THE PREFERRED EMBODIMENTS

### First Embodiment

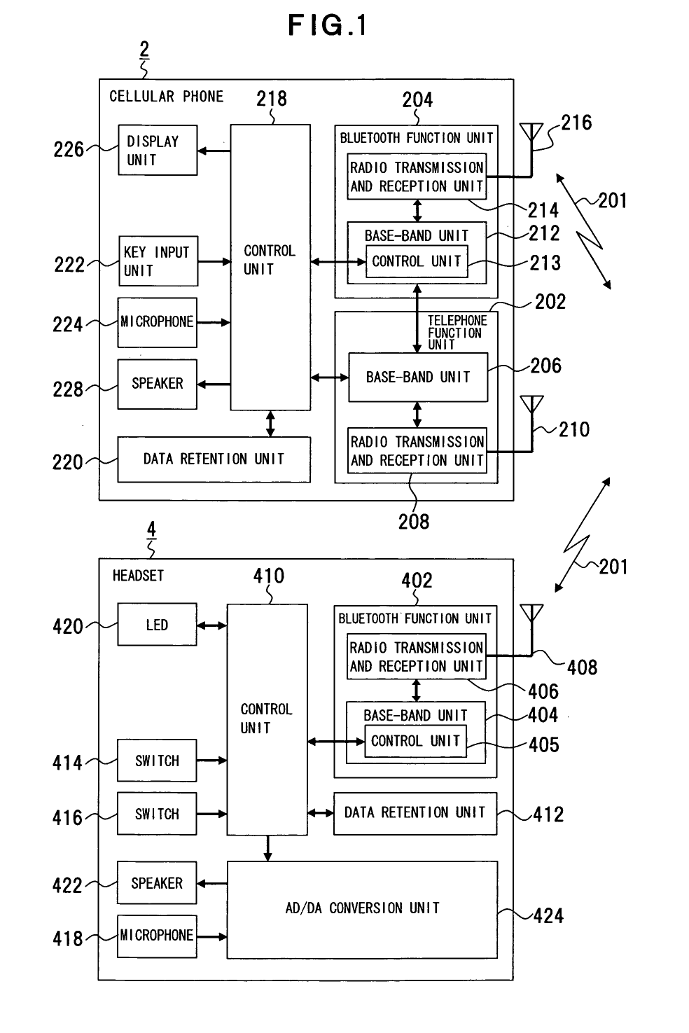

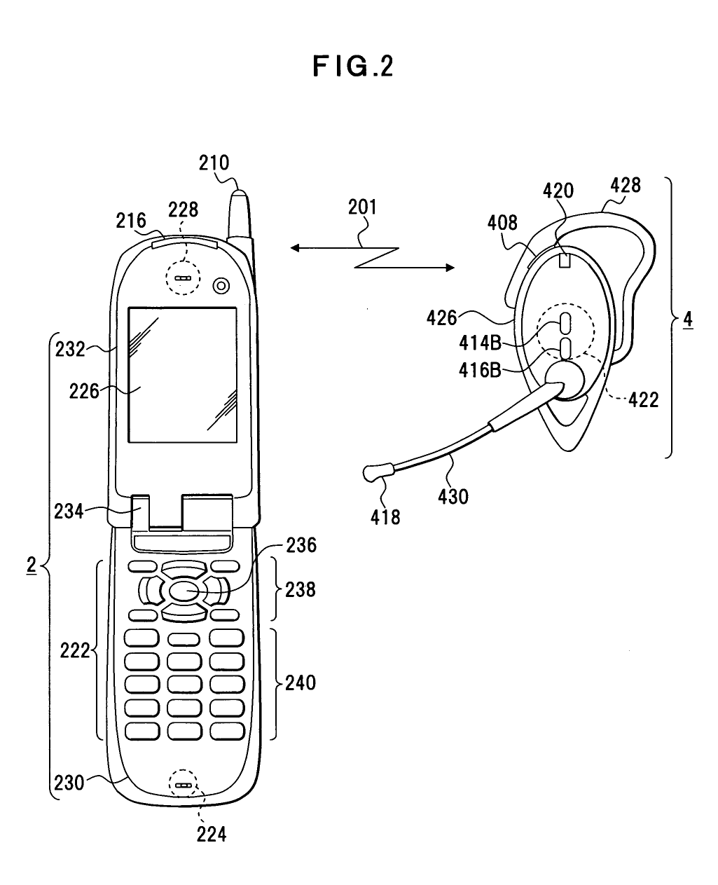

A first embodiment of the present invention is described with reference to FIG. 1 and FIG. 2. FIG. 1 is a block diagram showing a configuration example of an electronic device establishing a registration relationship, and FIG. 2 is a diagram showing a specific configuration example of an electronic device.

In this embodiment, for example, a cellular phone 2 is used as a first electronic device for establishing a functionally linked relationship and, for example, a headset 4 is used as a second electronic device which is a counterpart device of the first electronic device. Therefore, a registration relationship will be established between the cellular phone 2 and the headset 4 and a hands-free functionality will be established in the cellular phone 2 by the certain headset 4.

In the cellular phone 2, a telephone function unit 202 is a function unit responsible for phone calls via phone lines, and a Bluetooth function unit 204 is an example of an information transmission and reception unit for transmitting and receiving phone call signals and data signals. Although, as is well known, Bluetooth is a close-range radio communication standard, means for transmitting and receiving information should not be limited to Bluetooth and other radio transmission and reception functions may be used for data communications in this embodiment. In this embodiment, the Bluetooth function unit 204 constitutes a device information acquisition unit for obtaining device information via electromagnetic waves from the headset 4 which is the counterpart device.

In the telephone function unit 202, a base-band unit 206 performs modulation and demodulation of carrier signals with phone call signals, dial signals and the like, and a radio transmission and reception unit 208 transmits and/or receives radio signal waves through an antenna 210.

In the Bluetooth function unit 204, a base-band unit 212 performs signal processing such as modulation, demodulation, encryption or decryption of carrier signals with voice signals and data signals. The base-band unit 212 is provided with a control unit 213 performing various controls of registration processing and signal processing for generating authentication information from secret identification information described later, for example. The control unit 213 consists of a computer provided with a CPU (Central Processing Unit), a ROM (Read-Only Memory) as a storage medium, a RAM (Random-Access Memory) and the like, and this control unit 213 constitutes an authentication information generation unit for generating, for example, an authentication key as authentication information used for authenticating the counterpart device from the secret identification information. A radio transmission and reception unit 214 constitutes a communication unit for transmitting or receiving Bluetooth signal electric waves 201 through an antenna 216.

Also, a control unit 218 is provided in order to perform various controls such as data transmission and reception of the telephone function unit 202 and the Bluetooth function unit 204, and generation of a secret identification number as the secret identification information. The control unit 218 constitutes a secret information generation unit generating secret identification information to be assigned to the counterpart device. The control unit 218 consists of a computer provided with a CPU, a ROM as a storage medium, a RAM and the like and performs various controls, such as a phone call control by use of the telephone function unit 202 and the like, voice and data transmission and reception control by use of the Bluetooth function unit 204 and the like, display control, data and voice input and output control, function switching control and others. These controls are processed through such as execution of control programs stored in the ROM. The function switching control of the control unit 218 includes function switching such as, if the headset 4 is connected (linked) to the cellular phone 2, accordingly terminating functions of a microphone 224 and speaker 228 on the cellular phone 2 side as described later and enabling voice input through the headset 4.

A data retention unit 220 constitutes a storage unit storing the registration information and the like and stores data representing device names of electronic devices to be registered. The control unit 218 reads out these data and the data retention unit 220 stores new data such as data obtained from the counterpart device. This data retention unit 220 consists of, for example, a flash memory, as a memory which does not clear storage contents even if powered off.

In order to input and output information to and from the control unit 218, a key input unit 222 and the microphone 224 and the like are provided as an information input unit, and a display unit 226 and the speaker 228 and the like are provided as an information output unit. The key input unit 222 is used for inputting information such as telephone numbers, the secret identification numbers representing the secret identification information, and the like. The microphone 224 is used for capturing voice signals to the control unit 218. The display unit 226 consists of, for example, LCD (Liquid Crystal Display) elements and the like and displays various pieces of input information and output information to the control unit 218. The speaker 228 is used for regenerating voice signals output from the control unit 218 and the voice signals captured through the microphone 224.

In this case, the headset 4, i.e. the counterpart device of such a cellular phone 2 is provided with a function for communicating with the cellular phone 2 via Bluetooth standard as well as voice transmission and reception functions in the cellular phone 2. In this headset 4, a Bluetooth function unit 402 is an example of an information transmission and reception unit for transmitting and receiving the phone call signals and the data signals. As mentioned above, although Bluetooth is a close-range radio communication standard, as is the case with the cellular phone 2, in this headset 4, means for transmitting and receiving information should not be limited to Bluetooth and other radio transmission and reception functions may be used for data communications in this embodiment. In the Bluetooth function unit 402, a base-band unit 404 performs signal processing such as modulation, demodulation, encryption or decryption of carrier signals with voice signals and data signals. The base-band unit 404 is provided with a control unit 405 performing a control for such signal processing. The control unit 405 consists of a computer provided with a CPU, a ROM as a storage medium, a RAM and the like. A radio transmission and reception unit 406 constitutes a communication unit for transmitting or receiving the Bluetooth signal electric waves 201 through an antenna 408.

Also, a control unit 410 is provided in order to control the Bluetooth function unit 402. The control unit 410 consists of a computer provided with a CPU, a ROM as a storage medium, a RAM and the like and performs various controls, such as a registration control for the counterpart device, for example, the cellular phone 2, phone call control, voice and data transmission and reception control by use of the Bluetooth function unit 402 and the like, display control, data and voice input and output control and others. These controls are processed through such as execution of control programs stored in the ROM.

A data retention unit 412 is a storage unit consisting of readable and writable memory elements and stores various data such as device names of itself and electronic devices to be registered, data representing device addresses and the like. The control unit 410 reads out these data and the data retention unit 412 stores new data such as data obtained from the counterpart device. This data retention unit 412 consists of, for example, a flash memory, as a memory which does not clear storage contents even if powered off.

In order to input and output information to and from the control unit 410, a first switch 414 and second switch 416 is provided as a selection unit used for selecting on the headset 4 side whether a registration request from the cellular phone 2 should be responded or not, along with a microphone 418 and the like for voice input, and an LED indicator 420, speaker 422 and the like is provided as an information output unit or a notification unit. The switches 414, 416 are used for registering devices and for transmitting, receiving and terminating phone calls. In this case, between the control unit 410 and the microphone 418 as well as the speaker 422, an A (Analog) D (Digital)/DA conversion unit 424 is provided as a signal conversion unit. The AD/DA conversion unit 424 converts analog signals input from the microphone 418 into digital signals and converts digital signals output from the control unit 410 into analog signals.

As shown in FIG. 2, in the cellular phone 2 of this embodiment, first and second chassis units 230, 232 are coupled via a hinge unit 234 and are configured such that the chassis units 230, 232 can be folded around the hinge unit 234. The chassis unit 230 is provided with the key input unit 222 consisting of multiple keys, the microphone 224 and the like while the chassis unit 232 is provided with the display unit 226, the speaker 228, the antennas 210, 216 and the like. The key input unit 222 includes such as a decision key 236 for confirming inputs, cursor keys 238 used for selecting inputs, character keys 240 for entering numeric, alphabetic and Kana characters and the like. Although not shown in the figure, other structures are also built into the chassis unit 230 or 232.

The headset 4 of this embodiment is provided with a body unit 426 mounted on the ear, and the body unit 426 is provided with the speaker 422, switch buttons 414B, 416B corresponding to the switches 414, 416 and the LED indicator 420. The body unit 426 is provided with an ear-mount unit 428 as well as attached with an arm unit 430, and the microphone 418 is attached to the end of the arm unit 430.

According to such a configuration, the control unit 218 performs each type of processing depending on menus and the like displayed on the display unit 226 and key inputs from the key input unit 222, such as a control of the Bluetooth function unit 204, instructions for transmitting and receiving phone calls of the telephone function unit 202, data readout from the data retention unit 220.

At the time of phone calls using the headset 4, outgoing voices transmitted from the headset 4 are input into the base-band unit 206 of the telephone function unit 202 via the Bluetooth function unit 204 and output to telephone line network via the radio transmission and reception unit 208 of the telephone function unit 202. Also, incoming voice signals from the telephone line network are added to the Bluetooth function unit 204 from the telephone function unit 202, received by the antenna 408 of the Bluetooth function unit 402 of the headset 4 through the Bluetooth electric waves 201 from the Bluetooth function unit 204 and regenerated from the speaker 422 via the control unit 410 and the AD/DA conversion unit 424. Therefore, due to such processing, phone calls can be made through the speaker 422 and the microphone 418 of the headset.

At the time of device registration, through the display of the display unit 226 and input from the key input unit 222, the Bluetooth function unit 204 is instructed from the control unit 218 to perform a device search, and the search is performed for the electronic device to be registered, such as the headset 4, via Bluetooth signal electronic waves 201.

The base-band unit 404 built into the Bluetooth function unit 402 performs processing of transmission, reception and termination for the device registrations and phone calls of the cellular phone 2 via operations of the switch buttons 414B, 416B. Statuses of the registrations and phone calls are displayed by lighting of the LED indicator 420.

At the time of phone calls, input voices to the microphone 418 are digitized by the AD/DA conversion unit 424, and the digital voice signals are sent to the cellular phone 2 as the Bluetooth electric waves 201 via the base-band unit 404 and the radio transmission and reception unit 406 of the Bluetooth function unit 402. Also, the incoming voices are sent to the headset 4 from the cellular phone 2 via the Bluetooth function unit 204 and regenerated on the speaker 422 after converted to analog signals by the AD/DA conversion unit 424.

In the device registration to the cellular phone 2, a predefined command is issued from the control unit 218 to the Bluetooth function unit 204 to obtain information such as a device address from the headset 4 which is the electronic device to be registered. The cellular phone 2 uses the obtained device address to obtain a device name from the headset 4 and compare with a registration-target device name possessed in the data retention unit 220 in advance. If the device names are identical, a secret identification number is generated from the device address of the headset 4, and the secret identification number is used as authentication information. On the other hand, if the device name obtained from the headset 4 is different from the registration-target device name in the data retention unit 220 of the cellular phone 2, a user is requested (prompted) to input a secret identification number, and the secret identification number input by the user is used for the authentication.

By the way, at the time of the device registration, the user is notified by a lighting indication of the LED indicator 420 that a request for device registration from another device exists, and execution of the device registration is enabled by the user pressing down the switch button 414B after recognizing this indication.

According to such a configuration, complicated operations are not needed regarding the device registration, and by simplifying the device registration, the level of convenience can be increased such that a function not provided in one electronic devise is complemented by the other electronic device through linkage between the electronic devises, such as the establishment of the linkage relationship between the cellular phone 2 and the headset 4.

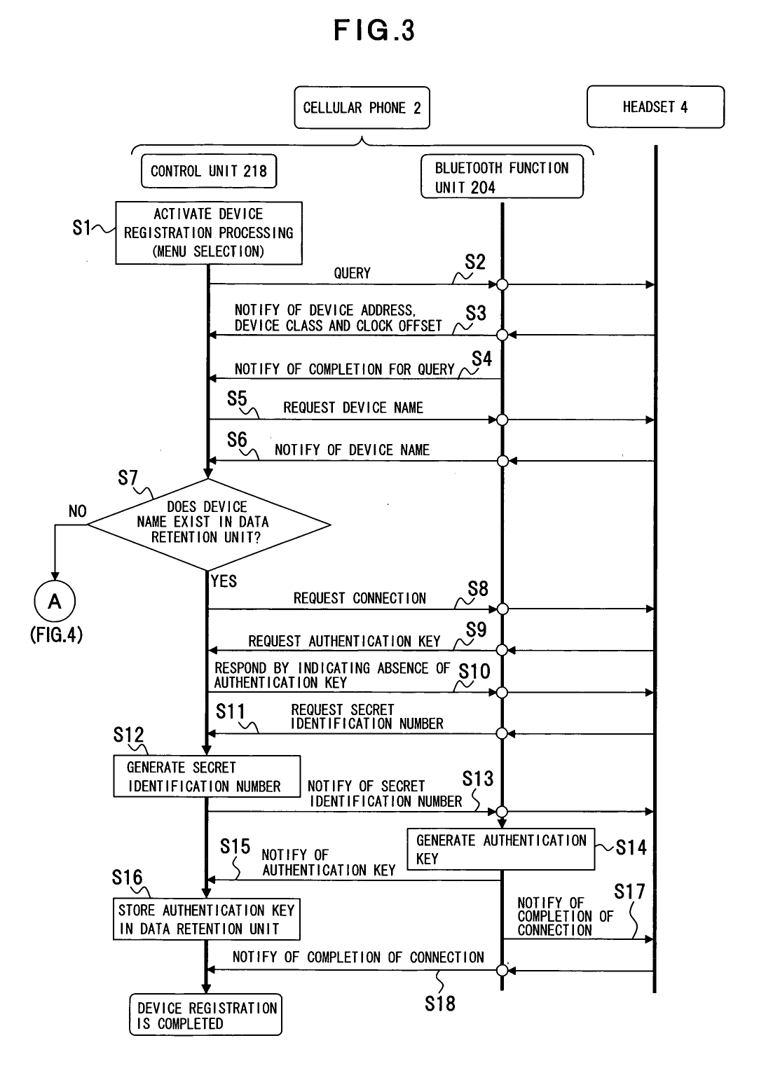

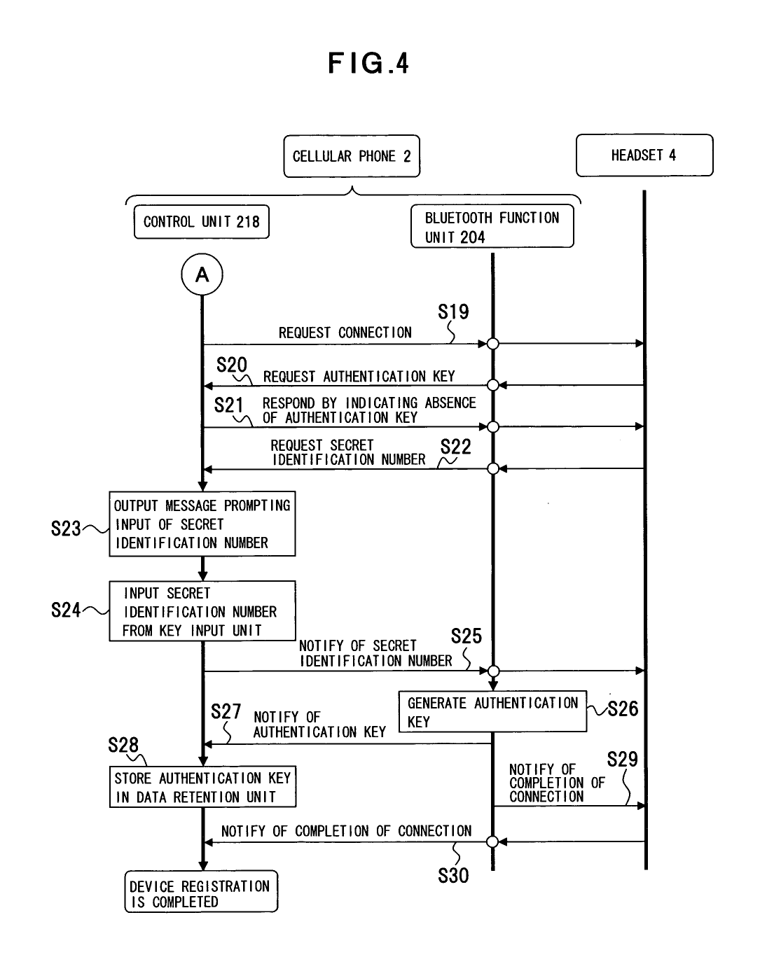

Then, the device registration of the cellular phone 2 and the headset 4 is described with reference to FIG. 3 and FIG. 4. FIG. 3 and FIG. 4 are flowcharts showing an example of a registration method and registration program by associating registration processing on the cellular phone 2 side with the headset 4. In FIG. 3 and FIG. 4, A indicates a connecting portion between the flowcharts.

If the headset 4 is registered with the cellular phone 2, a device registration is selected from a menu display of the cellular phone 2 to activate device registration processing (step S1). When the device registration processing is activated, a query is issued from the control unit 218 of the cellular phone 2 to the headset 4 via the Bluetooth function unit 204 (step S2), and as a result of the query, the headset 4 transmits notification of a device address, device class and clock offset (step S3). When predefined time has passed after this notification, the control unit 213 of the Bluetooth function unit 204 transmits notification for completion of the query to the control unit 218 (step S4). In response to this notification, the cellular phone 2 transmits a notification request for a device name to the headset 4 via the Bluetooth function unit 204 (step S5) and receives the notification of the device name from the headset 4 (step S6).

When receiving the notification of the device name, the control unit 218 of the cellular phone 2 decides whether the device name of the notification exists in the data retention unit 220 or not (Step S7). In other words, in this processing, a decision is made whether the device name of the notification is identical to the device name existing in the data retention unit 220 or not. If the device name does not exist, this processing makes the transition to step S18 of the flowchart shown in FIG. 4. If the device name representing the headset 4, i.e. the counterpart device, exists in the data retention unit 220, a connection request is transmitted to the headset 4 (step S8), and a notification request for an authentication key is transmitted from the headset 4 having received the connection request (step S9) If the authentication key does not exist in the cellular phone 2, a response is made which indicates that the authentication key does not exist (step S10), and this response triggers the headset 4 to transmit a request for the secret identification number (step S11). To this request for the secret identification number, the control unit 218 of the cellular phone 2 generates the secret identification number as the secret identification information (step S12) and notifies the headset 4 of the secret identification number via the Bluetooth function unit 204 (step S13). In this case, since the above-described device address obtained from the headset 4 (step S3) consists of a digit sequence of multiple numeric characters, the secret identification number is automatically generated as the last four (4) numeric characters of the digit sequence, for example.

Based on this generation of the secret identification number, in the Bluetooth function unit 204, the authentication key is generated by the control unit 213 from the secret identification number (step S14), and the control unit 218 is notified of the authentication key (step S15). The authentication key is stored in the data retention unit 220 of the cellular phone 2 (step S16). Then, the control unit 213 of the Bluetooth function unit 204 notifies the headset 4 of the completion of the connection (step S17); the headset 4 notifies the cellular phone 2 of the completion of the connection; and the registration processing with the cellular phone 2 is completed for the headset 4.

In step S7, if the device name does not exist in the data retention unit 220, the automatic generation processing of the secret identification number is not performed, and the devise registration is performed based on normal manual processing (FIG. 4). In this case, the connection request is transmitted from the control unit 218 to the headset 4 via the Bluetooth function unit 204 (step S19); the notification request for the authentication key is transmitted from the headset 4 having received the connection request (step S20); if the headset 4 has not been registered, the authentication key does not exist in the cellular phone 2, therefore, a response is made which indicates that the authentication key does not exist (step S21); and the headset 4 having received this response transmits the notification request for the secret identification number (step S22), which is received by the control unit 218.

When receiving this notification request for the secret identification number, a message prompting input of the secret identification number is displayed on the display unit 226 of the cellular phone 2 due to the display control of the control unit 218 (step S23), and after this display, the input of the secret identification number is accepted with the use of the character keys 240 of the key input unit 222 (step S24). The input secret identification number is notified from the control unit 218 to the headset 4 via the Bluetooth function unit 204 (step S25).

When receiving the notification of the secret identification number from the control unit 218, the Bluetooth function unit 204 generates the authentication key from the secret identification number (step S26). This authentication key is notified from the Bluetooth function unit 204 to the control unit 218 (step S27) and stored in the data retention unit 220 (step S28). Then, the notification of the completion of the connection is transmitted from the control unit 213 of the Bluetooth function unit 204 to the headset 4 (step S29); the notification of the completion of the connection is transmitted from the headset 4 to the cellular phone 2 (step S30); and when the control unit 218 receives the notification of the completion of the connection, the registration processing to the cellular phone 2 is completed for the headset 4.

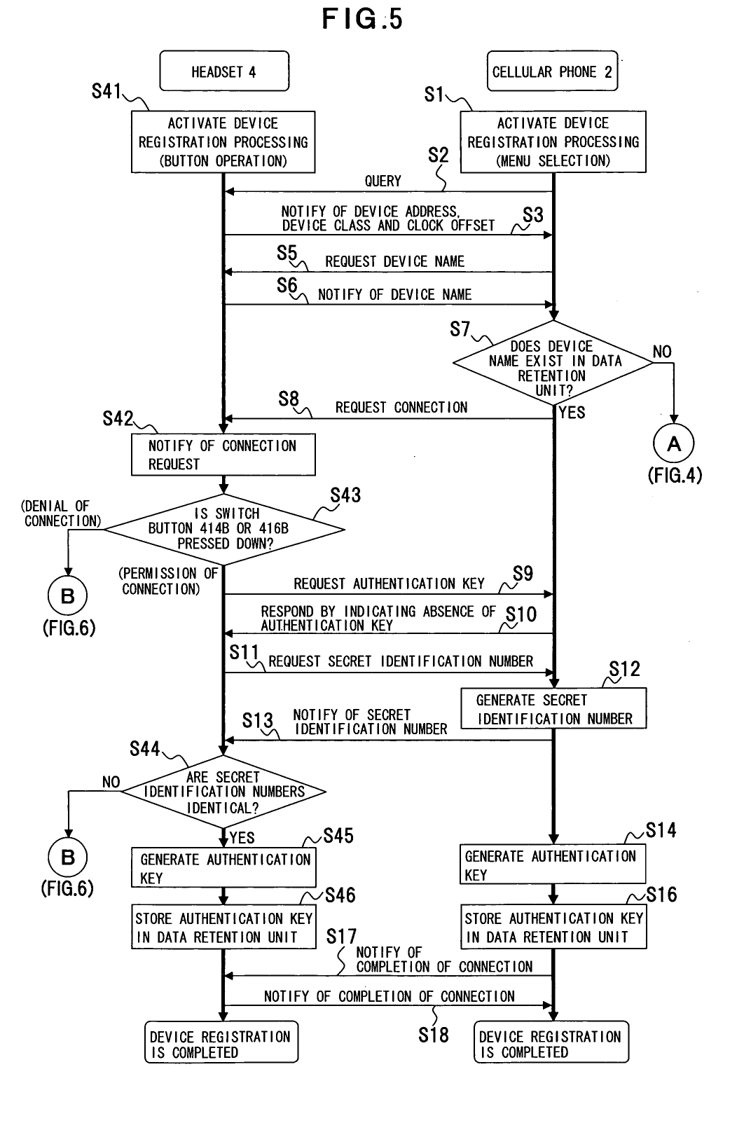

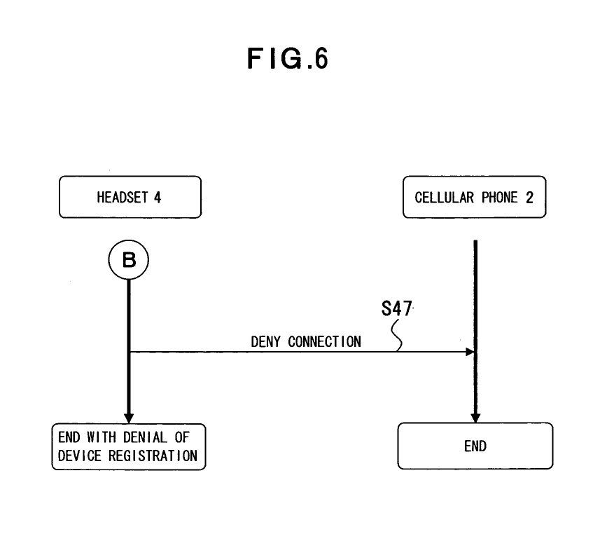

Then, the registration processing of the cellular phone 2 and the headset 4 is described with reference to FIG. 5 and FIG. 6. FIG. 5 and FIG. 6 are flowcharts showing one example of a registration method and registration program, which describe the processing on the headset 4 side in contrast with the processing on the cellular phone 2 (FIG. 3). In FIG. 5 and FIG. 6, A indicates a connecting portion to the flowchart shown in FIG. 4 and B indicates a connecting portion to the flowcharts shown in FIG. 6.

The device registration processing on the cellular phone 2 side is as shown in FIG. 3 and FIG. 4, and FIG. 5 is a flowchart showing device registration processing between the cellular phone 2 and the headset 4. By using the same symbols as FIG. 3 for the processing on the cellular phone 2 side, it is indicated that the processing is in common with the flowcharts shown in FIG. 3 and FIG. 4.

In the device registration process, the device registration processing is also activated in the headset 4 (step S41). In this case, the device registration processing is activated by pressing down either or both of the switch buttons 414B, 416B. During the activation, based on the device registration processing of the cellular phone 2, if the connection request is received (step S8) after the processing such as the query (step S2, S3, and S5 to S7), a notification is made for indicating that the connection request is being received (step S42). This notification is performed by, for example, a ringing sound from the speaker 422 representing the connection request. For the switch buttons 414B, 416B, if the switch button 414B has been made correspond to permission of the connection and the switch button 416B has been made correspond to denial of the connection, then by selectively pressing down the switch buttons 414B, 416B, the permission or denial of the connection is selected (step S43).

If the switch button 414B is pressed down, the secret identification number is notified to the head set 4 (step S13) after the request for the authentication key (step S9); the response from the cellular phone 2 indicating the absence of the authentication key (step S10); the request for the secret identification number as the request for the device registration to the cellular phone 2 (step S11); and the generation of the secret identification number on the cellular phone 2 side (step S12).

In the Bluetooth function unit 204 of the cellular phone 2, the authentication key is generated from the secret identification number (step S14), and this authentication key is stored in the data retention unit 220 via the control unit 218 (step S16).

On the headset 4 side, it is decided whether the notified secret identification number is identical to the secret identification number on the headset 4 side or not (step S44). If the secret identification numbers are not identical, the device registration processing is halted (FIG. 6); if the secret identification numbers are identical, the device registration processing continues to generate the authentication key from the secret identification number as is the case with the cellular phone 2 side (step S45), to store the authentication key in the data retention unit 412 (step S46), to notify the headset 4 of the completion of the connection (step S17), and to notify the cellular phone 2 of the completion of the connection (step S18). Thereafter, the device registration is completed on the cellular phone 2 side as well as on the headset 4 side. In the case where the secret identification numbers are not identical, the processing may be terminated once, and then the registration processing may be performed again.

In step S43, if the switch button 416B is pressed down for rejecting the connection, as shown in FIG. 6, a notification of the denial of the connection is transmitted; the registration processing is terminated on the headset 4 side by the denial of the device registration; and similarly, the cellular phone 2 side is notified of the denial of the connection and terminates the registration processing. The same processing is also performed when it is decided that the secret identification numbers are not identical in step S44 (FIG. 5).

As described above, according to the registration processing of the cellular phone 2 and the headset 4 of this embodiment, since the cellular phone 2 has the device name to be registered in advance, if the device name from the headset 4 is identical to the device name possessed beforehand, the secret identification number can be automatically sent to the headset 4 side to complete the device registration, to simplify the complicated operations of the device registration and to enhance linkage between the electronic devices, such as the cellular phone 2 and headset 4, and usability thereof.

Also, when receiving the connection request, the headset 4 seeks confirmation from the user to enable only the permitted device registration, i.e. the device registration of the headset 4 to be performed, and therefore reliability of the registration is ensured.

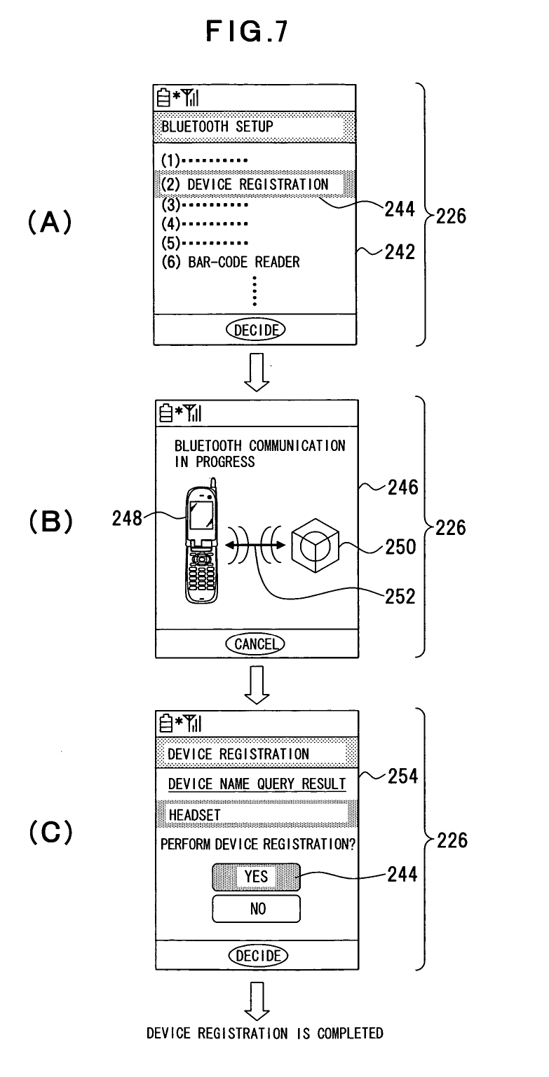

Then, the display on the cellular phone 2 side regarding the registration processing is described with reference to FIGS. 7A to 7C, FIGS. 8A to 8C and FIG. 9. FIGS. 7A to 7C, FIGS. 8A to 8C and FIG. 9 are diagrams showing display contents on the display unit 226 of the cellular phone 2.

On the cellular phone 2, when Bluetooth Setup is selected from an initial screen, a menu screen 242 shown in FIG. 7A is displayed on the display unit 226. The menu screen 242 displays “Bluetooth Setup” representing the current menu mode, “(1) . . . ”, “(2) Device Registration”, . . . , “(6) Bar-Code Reader”, . . . and others as well as “Decide” indicating the decision key 236. Therefore, by moving the cursor 244 to the “(2) Device Registration” with the cursor keys 238 and pressing down the decision key 236, the device registration processing is activated.

When the device registration processing is activated, since the query (step S2) is performed, the display unit 226 displays an operation screen 246 representing that the communication is in progress, as shown in FIG. 7B. This operation screen 246 displays an icon 248 for representing the cellular phone 2, an icon 250 for representing the counterpart device and an icon 252 for representing-Bluetooth connection therebetween as well as “Cancel” on the downside, which is an icon for canceling the query processing. The cancel processing is executed by pressing down the decision key 236.

Then, after the query (step S2) to the request for the device name (step S5) is performed, when receiving the notification of the request, if the device name exists in the data retention unit 220 (step S7), the display unit 226 of the cellular phone 2 displays a selection screen 254 shown in FIG. 7C. The selection screen 254 displays “Device Registration” for showing the processing mode, “Device Name Query Result” for showing details of the processing and “Headset” for showing the device name along with “Perform Device Registration?”, “Yes” and “No” as information for the selection as well as “Decide” indicating the operation of the decision key 236 on the downside. Therefore, the user can visually recognize the device name of the counterpart device to be registered, and if the user is willing to register the device, then by moving the cursor 244 to “Yes” and pressing down the decision key 236, the register processing is executed.

In this registration processing, the entire processing from the query (step S2) to the completion of the connection is automatically executed, and registration of the headset 4, i.e. the counterpart device, is performed as the device registration to the cellular phone 2.

After such registration is performed, by selecting the use of the headset 4 in the phone call mode, functions of the microphone 224 and the speaker 228 are halted on the cellular phone 2, and the functions are switched over to the voice transmission and reception using the registered headset 4. Therefore, the phone calls on the cellular phone 2 can be performed hands-free by use of the registered headset 4.

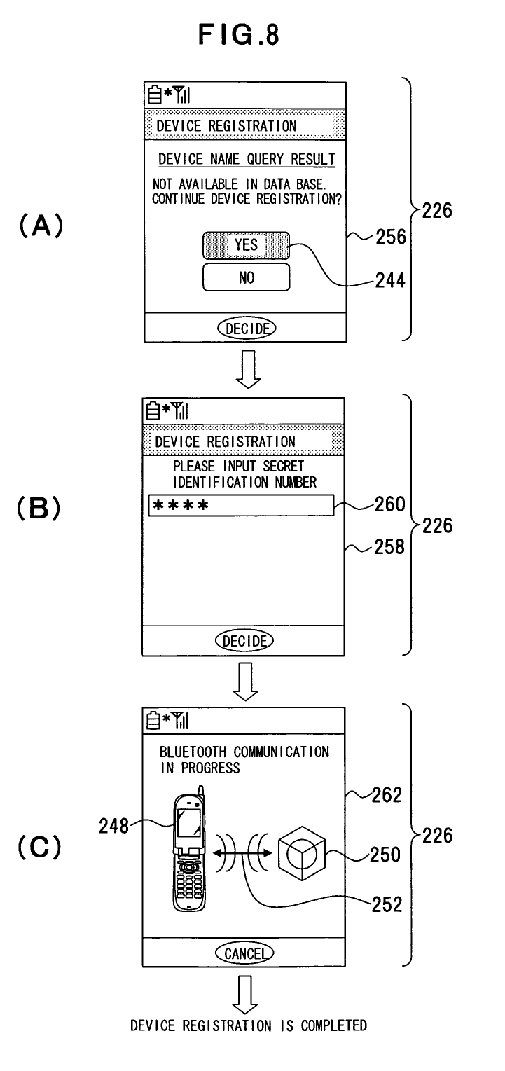

Then, if the device name does not exist in the data retention unit 220, a selection screen 256 is displayed, as shown in FIG. 8A. This selection screen displays “Device Registration” showing the processing mode, “Device Name Query Result” showing details of the processing along with “Not Available in Database. Continue Device Registration?”, “Yes” and “No” as information for the selection as well as “Decide” indicating the operation of the decision key 236 on the downside. Therefore, the user can confirm that the device name of the counterpart device to be registered does not exist, and if the user is willing to register the device, then by moving the cursor 244 to “Yes” and pressing down the decision key 236, the register processing continues.

If the registration processing is continued, as shown in FIG. 8B, an input screen 258 is displayed to prompt input of the secret identification number, and this input screen 258 displays “Device Registration” showing the processing mode and “Please Input Secret Identification Number” along with an input field 260 of the secret identification number as well as “Decide” indicating the operation of the decision key 236 on the downside. Therefore, after the user inputs, for example, four (4) numeric characters as the secret identification number into the input field 260 with the character keys 240, by pressing down the decision key 236, the registration processing continues.

When pressing down the decision key 236, as shown in FIG. 8C, an operation screen 262 is displayed representing that Bluetooth communication is in progress. This operation screen 262 displays the icon 248 for representing the cellular phone 2, the icon 250 for representing the counterpart device and the icon 252 for representing Bluetooth connection therebetween as well as “Cancel”, which is the icon for canceling the query processing, on the downside. The cancel processing is executed by pressing down the decision key 236. By maintaining this communication, the above-described device registration processing is executed during this communication.

### Second Embodiment

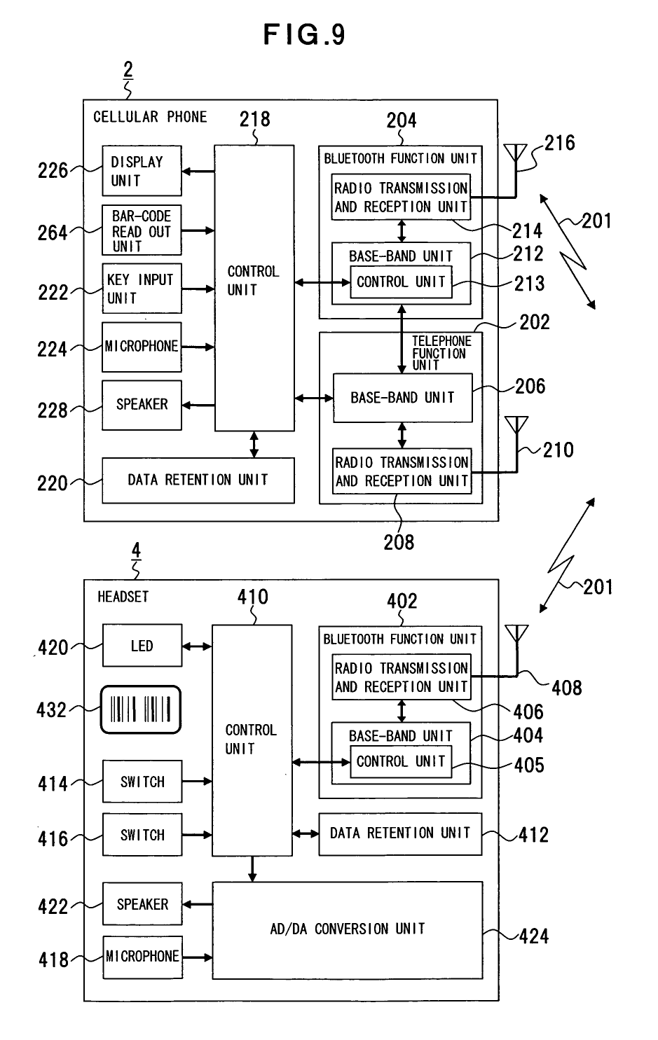

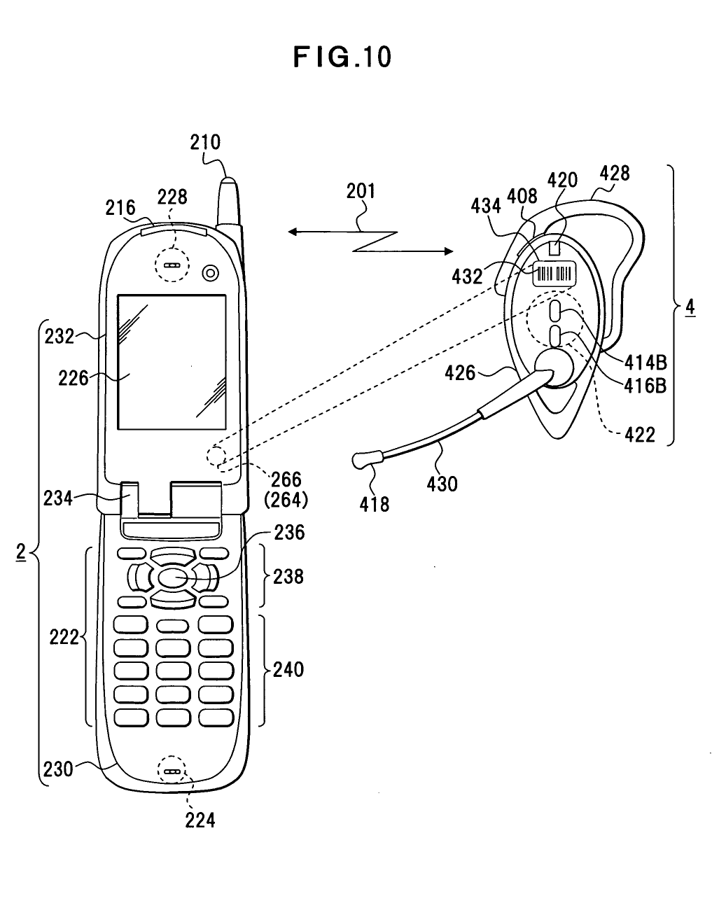

A second embodiment of the present invention is described with reference to FIG. 9 and FIG. 10. FIG. 9 is a block diagram showing a configuration example of an electronic device establishing a registration relationship, and FIG. 10 is a diagram showing a specific configuration example of an electronic device. In FIG. 9 and FIG. 10, the same symbols are added to the same portion as FIG. 1 and FIG. 2.

This embodiment enables a first electronic device to obtain information such as a device address representing a second electronic device and the secret identification number from display information such as a bar-code attached to the second electronic device.

Therefore, as the first electronic device, for example, the cellular phone 2 is provided with a bar-code read out unit 264 as an information acquisition unit, and information obtained by this bar-code read out unit 264 is input to the control unit 218. The bar-code read out unit 264 can consist of, for example, a camera as an imaging unit built into the cellular phone 2. The bar-code read out unit 264 may be configured for connecting a bar-code reader. In the cellular phone 2 of this embodiment, the Bluetooth function unit 204 constitutes a first device information acquisition unit for obtaining information such as the device address of the counterpart device, and the bar-code read out unit 264 constitutes a second device information acquisition unit. For this embodiment, description of each portion is omitted because other configuration is the same as the cellular phone 2 shown in FIG. 1.

Also, a bar-code 432 is attached to the headset 4, for example, as the second electronic device, and the bar-code 432 displays the device address and the secret identification number. Description of each portion is omitted because other configuration is the same as the headset 4 shown in FIG. 1.

In this embodiment, as shown in FIG. 10, the cellular phone 2 is provided with an imaging unit 266 constituting the bar-code read out unit 264, and the headset 4 is provided with a bar-code label 434 displaying the bar-code 432 on the backside of the body unit 426.

According to such a configuration, at the time of the device registration, the cellular phone 2 can obtain the device address and the secret identification number of the headset 4 by reading out the bar-code 432 on the headset 4 side with the bar-code read out unit 264 and can perform authentication using the device address and the secret identification number to simplify the registration processing.

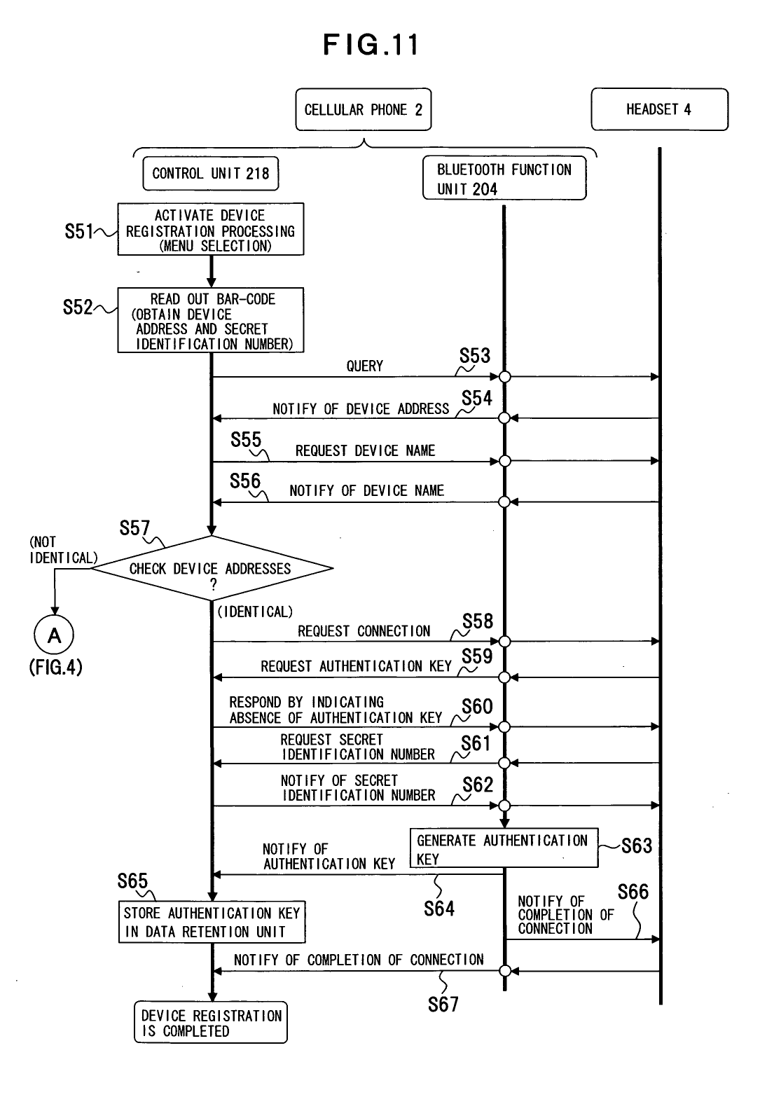

Then, the device registration of the cellular phone 2 and the headset 4 according to this embodiment is described with reference to FIG. 11. FIG. 11 is a flowchart showing registration processing by associating registration processing on the cellular phone 2 side with the headset 4. In FIG. 11, A indicates a connecting portion with the flowchart shown in FIG. 4.

If the headset 4 is registered with the cellular phone 2, a device registration is selected from a menu display of the cellular phone 2 to activate device registration processing (step S51). When the device registration processing is activated, the bar-code read out unit 264 is activated from the control unit 218 of the cellular phone 2 to read out the bar-code 432 (step S52). Since the bar-code 432 includes the device address, the secret identification number and the like, the device address and the secret identification number are obtained from the bar-code 432. Since the device address and the secret identification number of the headset 4 are obtained by reading out the bar-code, the cellular phone 2 side does not have to generate the secret identification number to the headset 4 in this embodiment.

After reading out the bar-code, the cellular phone 2 performs a query to the headset 4 regarding the registration (step S53), receives notification of the device address from the headset 4 (step S54), requests the device name (step S55) and receives notification of the device name from the headset 4 (step S56).

Then, the control unit 218 checks the device address (step S57) to compare the device address with the device address obtained from the bar-code 432 and decides whether the device addresses are identical or not. If the device addresses are not identical, the processing makes the transition to step S19 of the flowchart shown in FIG. 4. If the device addresses are identical, a connection request is performed to the headset 4 (step S58), and after a request for the authentication key (step S59) and the response indicating that the authentication key does not exist (step S60), a request for the secret identification number is received from the headset 4 (step S61), and the notification of the secret identification number is notified from the control unit 218 to the headset 4 via the Bluetooth function unit 204 (step S62).

When receiving the notification of the secret identification number, the Bluetooth function unit 204 generates the authentication key from the secret identification number (step S63) and notifies the control unit 218 of the authentication key (step S64), and subsequently, the control unit 218 stores the authentication key in the data retention unit 220 (step S65). The Bluetooth function unit 204 transmits the notification of the completion of the connection to the headset 4 (step S66), and the headset 4 transmits the notification of the completion of the connection which is received by the control unit 218. After these processing, the device registration is completed.

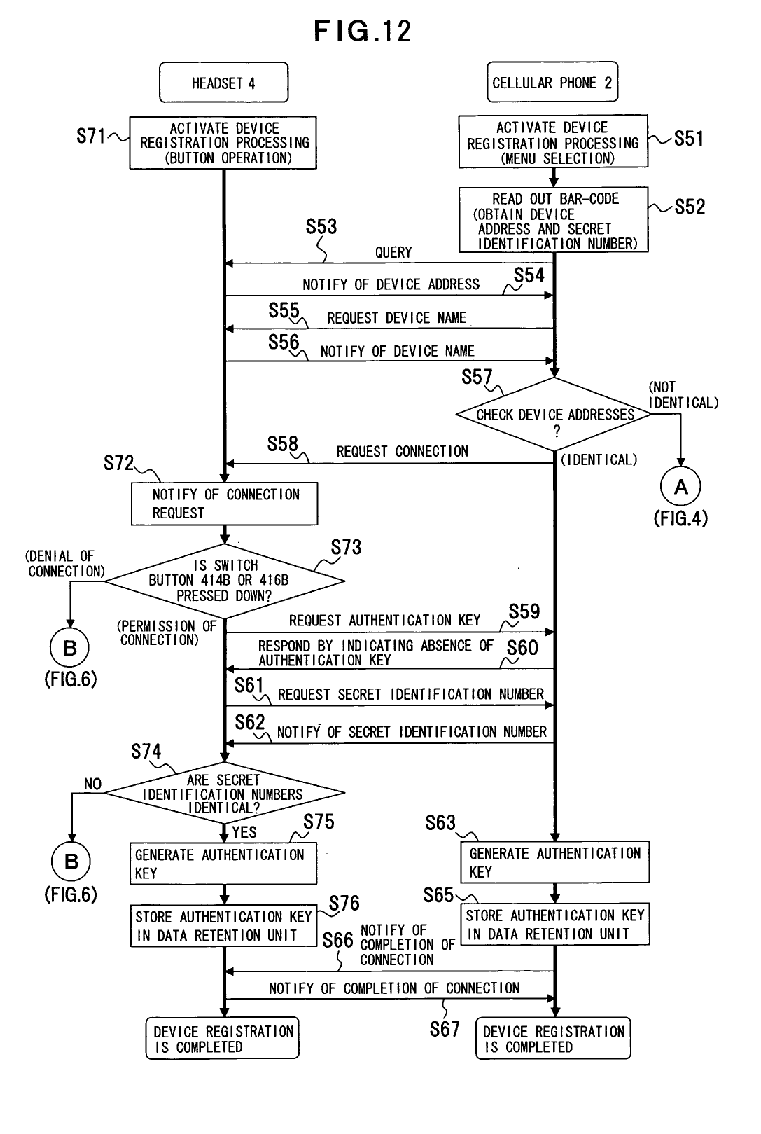

Then, the registration processing of the cellular phone 2 and the headset 4 is described with reference to FIG. 12. FIG. 12 is a flowchart showing processing on the headset 4 side in contrast with the processing of the cellular phone 2 (FIG. 11). In FIG. 12, A indicates a connecting portion to the flowchart shown in FIG. 4 and B indicates a connecting portion to the flowcharts shown in FIG. 6.

The device registration processing on the cellular phone 2 side is as shown in FIG. 11, and FIG. 12 is a flowchart showing processing of the registration method and the registration program of the device registration between the cellular phone 2 and the headset 4. By using the same symbols as FIG. 11 for the processing on the cellular phone 2 side, it is indicated that the processing is in common with the flowchart shown in FIG. 11.

In the device registration processing, the device registration processing is also activated in the headset 4 (step S71). In this case, the device registration processing is activated by pressing down either or both of the switch buttons 414B, 416B. During the activation, based on the device registration processing of the cellular phone 2 (step S51), the bar-code read out processing (step S52) is executed.

After the bar-code read out processing, the processing goes through the query (step S53), the notification of the device address from the headset 4 (step S54), the request for the device name (step S55), the notification of the device name (step S56) and the check of the device address (step S57), and when the connection request is received (step S58), a notification is made for indicating that the connection request is being received (step S72). This notification is performed by, for example, a ringing sound from the speaker 422 representing the connection request. For the switch buttons 414B, 416B, if the switch button 414B has been made correspond to permission of the connection and the switch button 416B has been made correspond to denial of the connection, then by selectively pressing down the switch buttons 414B, 416B, the permission or denial of the connection is selected (step S73).

If the switch button 414B is pressed down, as described above, after performing the request for the authentication key (step S59); the notification from the cellular phone 2 indicating the absence of the authentication key (step S60); and the request for the secret identification number as the request for the device registration to the cellular phone 2 (step S61), the secret identification number already obtained in step S52 is notified to the headset 4 (step S62).

On the headset 4 side, it is decided whether the notified secret identification number is identical to the secret identification number on the headset 4 side or not (step S74). If the secret identification numbers are not identical, the device registration processing is halted (FIG. 6); if the secret identification numbers are identical, the registration processing continues to generate the authentication key from the secret identification number as is the case with the cellular phone 2 side (step S75), to store the authentication key in the data retention unit 412 (step S76), to notify the headset 4 of the completion of the connection (step S66), and to notify the cellular phone 2 of the completion of the connection (step S67). Thereafter, the device registration is completed on the cellular phone 2 side as well as on the headset 4 side.

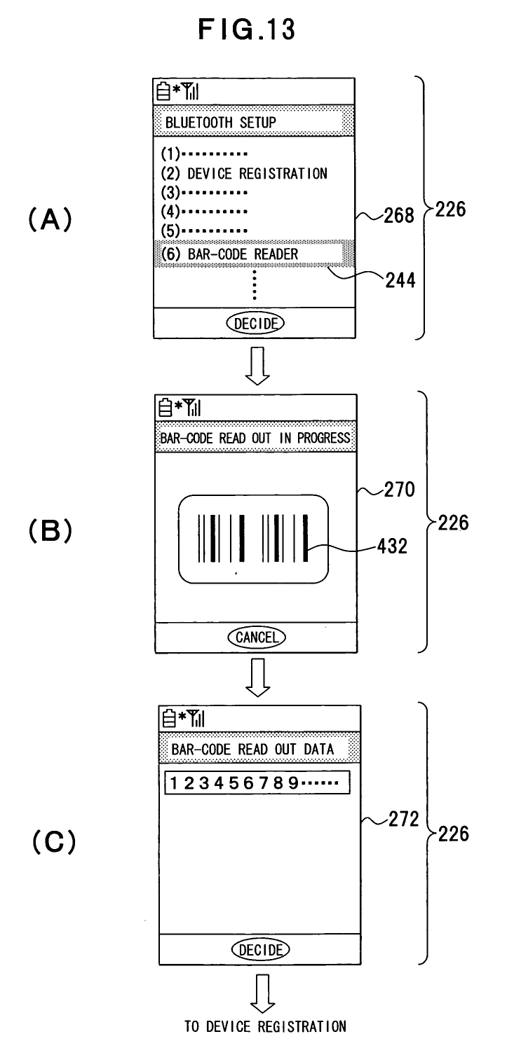

Then, the display on the cellular phone 2 side regarding the registration process is described with reference to FIGS. 13A to 13C. FIGS. 13A to 13C are diagrams showing display contents on the display unit 226 of the cellular phone 2.

On the cellular phone 2, when Bluetooth Setup is selected from an initial screen, a menu screen 268 shown in FIG. 13A is displayed on the display unit 226. The menu screen 268 displays “Bluetooth Setup” representing the current menu mode, “(1) . . . ”, “(2) Device Registration”, . . . , “(6) Bar-Code Reader”, . . . and others as well as “Decide” indicating the decision key 236. Therefore, by moving the cursor 244 to the “(6) Bar-Code Reader” with the cursor keys 238 and pressing down the decision key 236, the bar-code read out is activated.

When the bar-code read out is executed, an operation screen 270 is displayed for representing that the bar-code read out is in progress, as shown in FIG. 13B. This operation screen 270 displays “Bar-code read out in progress” and a bar-code 432 as well as “Cancel” on the downside, which is an icon for canceling the bar-code read out processing. The cancel processing is executed by pressing down the decision key 236.

When the read out of the bar-code 432 is completed, the display unit 226 displays an operation screen 272 shown in FIG. 13C. This operation screen 272 displays “Bar-Code Read Out Data” representing details of the processing, numerical characters which are data recognized from the bar-code 432 as well as “Decide” indicating the operation of the decision key 236 on the downside. Therefore, if the user is willing to register the device, then by pressing down the decision key 236, the register processing is executed.

In this registration processing, the entire processing from the query (step S53) to the completion of the connection is automatically executed, and registration of the headset 4, i.e. the counterpart device, is performed as the device registration with the cellular phone 2. If the device address obtained from the bar-code 432 is not identical to the device address obtained by the query, the processing screen is displayed as described with reference to FIGS. 8A, 8B and 8C.

After such registration is performed, by selecting the use of the headset 4 in the phone call mode, functions of the microphone 224 and the speaker 228 are halted on the cellular phone 2, and the functions are switched over to the voice transmission and reception using the registered headset 4. Therefore, the phone calls on the cellular phone 2 can be performed hands-free by use of the registered headset 4.

### Other Embodiments

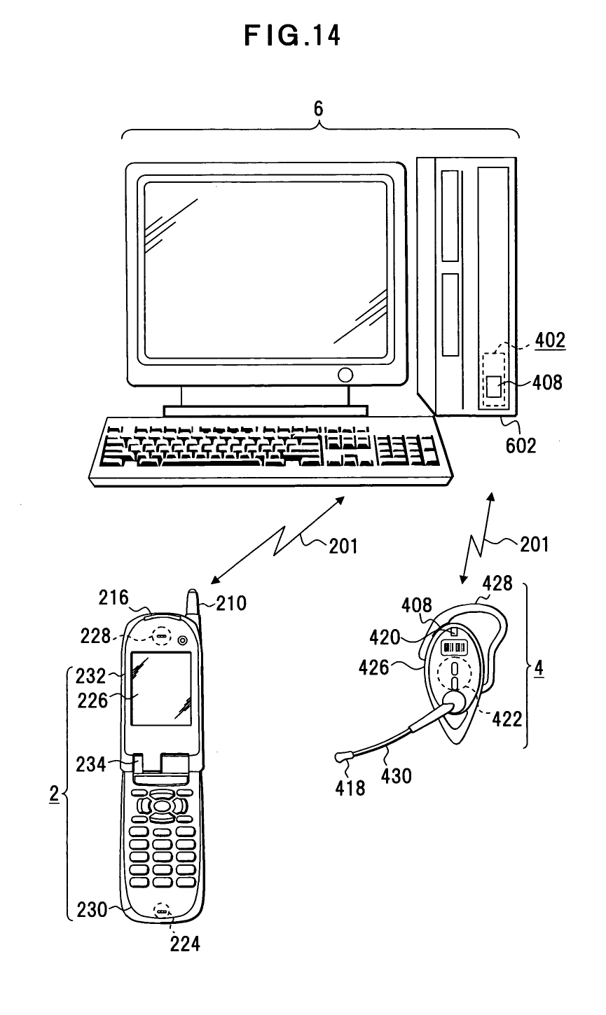

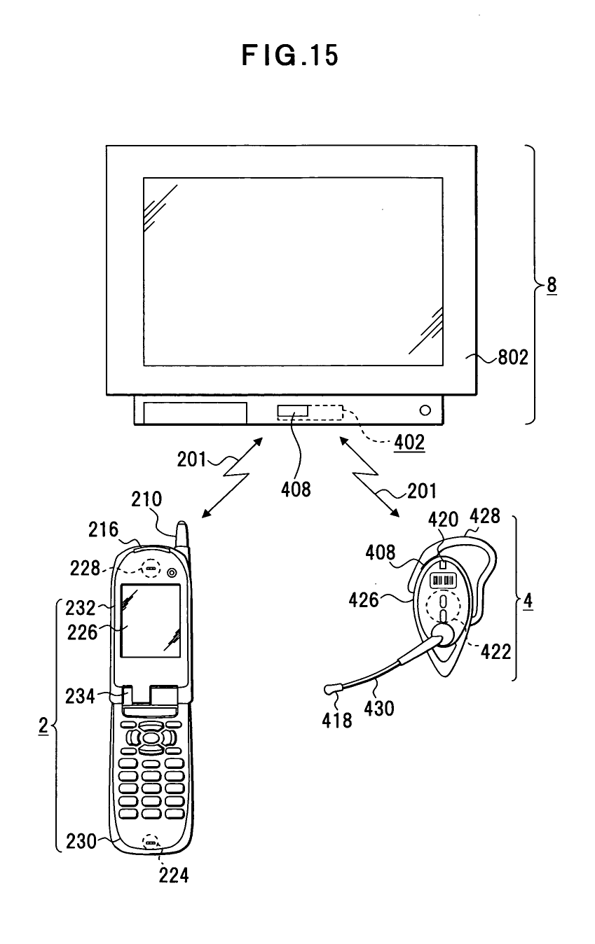

Then, other embodiments are described with reference to FIG. 14 and FIG. 15. FIG. 14 is a diagram showing a configuration example using a personal computer (PC) as the target of the registration, and FIG. 15 is a diagram showing a configuration example using a TV receiver as the target of the registration.

In above-described embodiments, the cellular phone 2 and headset 4 are illustrated as the fist and second electronic devices, respectively, however, as shown in FIG. 14, the first electronic device may be the cellular phone 2 or the headset 4, and the second electronic device may be configured as a PC 6. In this case, by incorporating, for example, the Bluetooth function unit 402 illustrated for the headset 4 (FIG. 1 or FIG. 9) into a body unit 602 of the PC 6, the linkage relationship can be maintained between the cellular phone 2 or the headset 4 and the PC 6 by the above-described device registration. As described above, the registration can be performed with the simplified processing which skips procedures of the secret identification number input or the like.

Also, as shown in FIG. 15, the first electronic device may be the cellular phone 2 or the headset 4, and the second electronic device may be configured as a TV receiver 8. In this case, by incorporating, for example, the Bluetooth function unit 402 illustrated for the headset 4 (FIG. 1 or FIG. 9) into a body unit 802 of the TV receiver 8, the linkage relationship can be maintained between the cellular phone 2 or the headset 4 and TV receiver 8 by the above-described device registration. In this way, in the linkage between the TV receiver 8 and the cellular phone 2, by establishing an advanced communication form such as bidirectional communication with the simplified registration processing in addition to a selection operation of a receiving channel and the like, the cellular phone 2 can be used for transmission and reception of voices and data through the mediation of the TV receiver 8. Also, in the linkage between the TV receiver 8 and the headset 4, not only audio output can be switched over to the headset 4, but also, when the bidirectional communication is established, the audio input can be transmitted and received through the Bluetooth function unit 402 of the TV receiver 8 using the microphone 418 provided in the headset 4.

As other embodiments, the present invention can be applied to registration between multiple electronic devices and can be used for registration between various electronic devices, such as the cellular phone 2 and a home electric appliance, the cellular phone 2 and an electronic notepad, or the cellular phone 2 and a control unit of an automobile.

Although, in the embodiments described above, electromagnetic waves conforming to a communication standard for Bluetooth are used as a transmission medium for the registration between the electronic devices, standards other than Bluetooth may be used, and the transmission medium for the close-range radio communication may be wireless, such as voices or supersonic waves, as well as wired.

Although, in the embodiments described above, the ROM and others are illustrated as a storage medium storing the programs and control information, the present invention is not limited to the ROM and others, and a storage medium such as an external memory element may be used.

As mentioned above, according to the present invention, the procedures of the secret identification number input or the like can be skipped regarding the registration between electronic devices used for coordination and complementation of functions among devices, and the present invention is useful because the registration processing can be simplified as well as the level of convenience can be enhanced for the electronic devices.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

The entire disclosure of Japanese Patent Application No. 2005-080701 including specification, claims, drawings and summary are incorporated herein by reference in its entirety.

What is claimed is:

1. An electronic device comprising:
a device information acquisition unit obtaining device information from a counterpart device which is a registration target;
a storage unit storing device information representative of the registration target; and
a secret identification information generation unit comparing the device information stored in the storage unit with the device information obtained from the counterpart device and generating secret identification information to be applied to the counterpart device if both of the device information are identical.

2. The electronic device of claim 1, wherein the secret identification information is generated by use of a device address obtained from the counterpart device.

3. The electronic device of claim 1, further comprising an authentication information generation unit generating authentication information used for authentication of the counterpart device from the secret identification information generated in the secret identification information generation unit.

4. The electronic device of claim 1, wherein the secret identification information generation unit compares the device information stored in the storage unit with device information of the counterpart device and generates display information prompting input of secret identification information to be applied to the counterpart device, if both of the device information are not identical.

5. The electronic device of claim 1, wherein the device information acquisition unit reads out device information displayed on the counterpart device which is the registration target, from an image.

6. An electronic device comprising:
a notification unit transmitting a notification representative of a registration request upon receiving the registration request from a counterpart device;
a selection unit selecting whether to respond to the registration request; and
a communication unit notifying the counterpart device of instruction information identified by the selection unit.

7. A registration method of an electronic device, comprising the operations of:
obtaining device information from a counterpart device which is a registration target;
comparing device information stored in a storage unit with the device information obtained from the counterpart device; and
generating secret identification information to be applied to the counterpart device if both of the device information are identical in the comparison.

8. The registration method of an electronic device of claim 7, further comprising the operation of generating authentication information used for authentication of the counterpart device from the secret identification information.

9. The registration method of an electronic device of claim 7, further comprising the operation of comparing the device information stored in the storage unit with device information of the counterpart device and generating display information prompting input of secret identification information to be applied to the counterpart device, if both of the device information are not identical.

10. The registration method of an electronic device of claim 7, further comprising the operation of reading out device information displayed on the counterpart device which is the registration target, from an image.

11. A computer readable storage medium storing an electronic device registration program executed by a computer, the storage medium storing the electronic device registration program comprising the steps of:
obtaining device information from a counterpart device which is a registration target;
comparing device information stored in a storage unit with the device information obtained from the counterpart device; and
generating secret identification information to be applied to the counterpart device if both of the device information are identical in the comparison.

12. The storage medium of claim 11, wherein the electronic device registration program further comprises the step of generating authentication information used for authentication of the counterpart device from the secret identification information.

13. The storage medium of claim 11, wherein the electronic device registration program further comprises the step of comparing the device information stored in the storage unit with device information of the counterpart device and generating display information prompting input of secret identification information to be applied to the counterpart device, if both of the device information are not identical.

14. The storage medium of claim 11, wherein the electronic device registration program further comprises the step of reading out device information displayed on the counterpart device which is the registration target, from an image.
